(19) United States
(12) Patent Application Publication
(10) Pub. No.: US 2014/0292774 A1
(43) Pub. Date: Oct. 2, 2014

(54) SYSTEM AND METHOD FOR PERFORMING SAMPLE-BASED RENDERING IN A PARALLEL PROCESSOR

(71) Applicant: NVIDIA CORPORATION, Santa Clara, CA (US)

(72) Inventors: Stefan Radig, Berlin (DE); Daniel Levesque, Berlin (DE); Carsten Wächter, Berlin (DE); Daniel Seibert, Berlin (DE)

(73) Assignee: Nvidia Corporation, Santa Clara, CA (US)

(21) Appl. No.: 13/850,448

(22) Filed: Mar. 26, 2013

(51) Int. Cl. G06T 1/20

(52) U.S. Cl. CPC G06T 1/20
USPC 345/505

(57) ABSTRACT

A processing system, a method of carrying out sample-based rendering (such as true or quasi-Monte Carlo rendering) in a multi- or many-core processor processing system and a graphics processing unit (GPU) incorporating the processing system or the method. In one embodiment, the processing system includes: (1) a sample-space distributor operable to distribute a first subset of samples for a pixel of an image to a first compute core for sample-based rendering therewith and a second subset of samples for the pixel to a second compute core for the sample-based rendering therewith, the second subset differing from the first subset and (2) a sample-space combiner associated with the sample-space distributor and operable to combine results of the sample-based rendering.

### TECHNICAL FIELD

This application is directed, in general, to computer graphics and, more specifically, to a sample-based rendering system and a method of operating the same to carry out sample-based rendering.

### BACKGROUND

Sample-based rendering systems, which employ true Monte Carlo (MC) or quasi-MC (QMC) sampling techniques and are sometimes referred to simply as sample-based renderers, generate an image by accumulating multiple samples for each pixel of the image and averaging the samples to calculate a resulting pixel color value. The MC or QMC sampling techniques are employed to generate ray origins, ray directions, and other factors. The quality or fidelity of an image increases as more samples are taken for every pixel. Modern applications for sample-based renderers may employ 100 or more samples per pixel, and the number of samples per pixel is likely to continue to increase in the future.

Conventionally, sample-based rendering is scaled to multiple compute resources (e.g., compute cores of a multi- or many-core processor, such as a graphics processing unit, or GPU, or central processing unit, or CPU) by assigning different areas of an image to be rendered to different resources. The different areas are then joined to one another and displayed.

### SUMMARY

One aspect provides a processing system. In one embodiment, the processing system includes: (1) a sample-space distributor operable to distribute a first subset of samples for a pixel of an image to a first compute core for sample-based rendering therewith and a second subset of samples for the pixel to a second compute core for the sample-based rendering therewith, the second subset differing from the first subset and (2) a sample-space combiner associated with the sample-space distributor and operable to combine results of the sample-based rendering.

Another aspect provides a method of carrying out sample-based rendering in a multi- or many-core processor of a processing system. In one embodiment, the method includes: (1) distributing a first subset of samples for a pixel of an image to a first compute core of the processing system for the sample-based rendering, (2) distributing a second subset of samples for the pixel to a second compute core of the processing system for the sample-based rendering, the second subset differing from the first subset and (3) combining results of the sample-based rendering from the first and second compute cores.

Yet another embodiment provides a GPU, including: (1) at least 50 compute cores including first and second compute cores, (2) a sample-space distributor operable to distribute a first subset of samples for a pixel of an image to the first compute core for sample-based rendering therewith and a second subset of samples for the pixel to the second compute core for the sample-based rendering therewith, the second subset differing from the first subset and (3) a sample-space combiner associated with the sample-space distributor and operable to combine results of the sample-based rendering.

### BRIEF DESCRIPTION

Reference is now made to the following descriptions taken in conjunction with the accompanying drawings, in which:

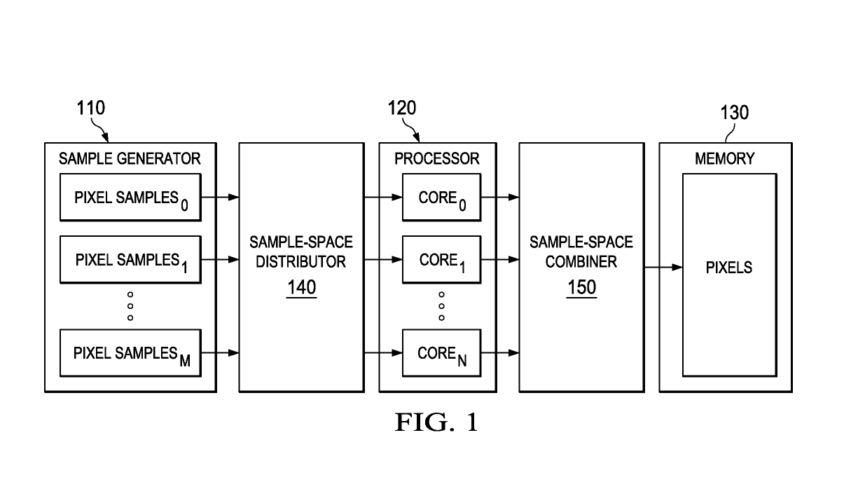

FIG. 1 is a block diagram of one embodiment of a multi- or many-core processing system; and

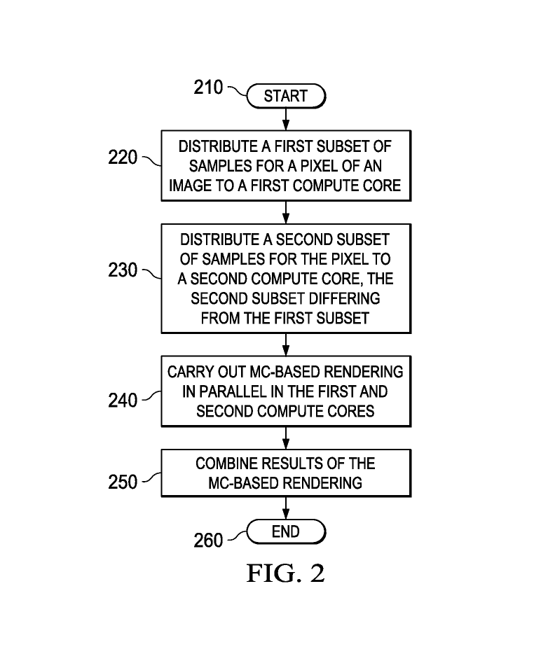

FIG. 2 is a flow diagram of one embodiment of a method of carrying out sample-based rendering in a multi- or many-core processor of a processing system.

### DETAILED DESCRIPTION

As stated above, conventional sample-based rendering is adapted to be carried out in multiple compute resources by assigning different areas of an image to be rendered to different resources. More specifically, all samples pertaining to pixels in a given area of an image are assigned to a given resource. However, it is realized herein that this intuitively attractive methodology has a subtle but serious drawback in terms of load balancing among the various resources. It is more specifically realized herein that some pixels of a given image are usually faster to render than others and that some areas of a given image tend to be faster to render than others. It is further realized herein that the number of interactions between or among objects required to be taken into account to render a given pixel greatly impacts the computational complexity of the rendering. For example, a first area of a given image may show only an environmental map, while a second area of the same image may show a car headlight. The first area involves only a single object and is therefore likely to be trivial to render. On the other hand, the second area may require many ray/material interactions to be taken into account. Consequently, rendering the second area may be several orders of magnitude more complex than the first area.

It is yet further realized herein that computational disparity tends to grow not only as the number of samples per pixel grows but also as the image is divided into smaller areas and distributed over more compute resources. In other words, the conventional methodology is likely to become more problematic as the scale of its parallelism increases. It is still further realized herein that apportioning sample-based rendering in this conventional manner to 100 or more compute cores may be exceedingly inefficient, problematic and perhaps impossible to carry out in real time at video frame rates.

Introduced herein are various embodiments of a sample-based-based rendering system and a method of operating the same. In general, the embodiments apportion the samples pertaining to a given pixel to multiple resources rather than apportioning all of the samples of the given pixel to a given resource for rendering. Following rendering, the results are combined. In one embodiment, the results are combined by averaging. In stark contrast to the above-described conventional methodology (in which the area of the image is divided and apportioned among multiple compute resources), the embodiments described herein may be thought of as dividing and apportioning among multiple resources the sample space that is involved in rendering each pixel of the image.

In certain embodiments, the system and method apportion a single sample for each of the pixels in the whole image to a single resource. Thus, for example, should each pixel involve 100 samples, each of 100 compute cores would receive a single sample for all of the pixels in the image for rendering. The 100 results would then be combined to form the ultimate image.

In other embodiments, the system and method apportion more than a single sample, but fewer than all samples, for each of the pixels of only part of the area of the image to a single resource. Thus, for example, should each pixel involve 200 samples, each of 50 compute cores might receive four samples for pixels in only a part of the area of the image for rendering. Assuming the part of the area allocated to the 50 compute cores is a quarter of the image, a total of 200 compute cores may be involved in rendering the whole image.

In yet other embodiments, the system and method apportion more than a single sample, but fewer than all samples, from each of the pixels of the whole image to a single resource. Thus, for example, should each pixel involve 500 samples, each of 100 compute cores might receive five samples for every pixel of the image for rendering.

In still other embodiments, a single combination is performed to combine the results of the rendering in the various resources. Thus, for example, should each pixel involve 200 samples, and 200 compute cores be involved in rendering the samples, the 200 results would be combined in a single operation.

In yet still other embodiments, multiple partial combinations are performed to combine the results of the rendering in the various resources. Thus, for example, should each pixel involve 200 samples and 200 compute cores be involved in rendering the samples, the 200 intermediate results might be partially combined into 100 intermediate results, which might be partially combined into 25 intermediate results, and so on (at any desired fan-in rate) until a full combination occurs.

In embodiments to be illustrated and described, the combination involves a simple (unweighted) average. Other embodiments employ other conventional or later-developed combinations, such as additions or weighted averages.

FIG. 1 is a block diagram of one embodiment of a multi- or many-core processing system. The processing system includes a sample generator 110 operable to generate samples for the pixels that constitute an image. For example, if an image contains M pixels, the sample generator 110 generates M corresponding subsets of samples, referenced in FIG. 1 as pixel samples₀, pixel samples₁, . . . , pixel samples_{M}.

The processing system further includes a processor 120 operable to process the samples for the pixels that constitute the image. In one embodiment, the processor 120 is a GPU having multiple resources, i.e., cores. The embodiment illustrated in FIG. 1 has N cores: referenced as core₀, core₁, . . . , core_{N}. N may be any positive integer number greater than one. In one embodiment, N is at least 50. In another embodiment, N is at least 100.

The processing system also includes a memory 130 coupled to the processor 120. The memory 130 is operable to store the pixels of the rendered image.

A sample-space distributor 140 is coupled to the sample generator 110 and the processor 120. In the illustrated embodiment, the sample-space distributor 140 is operable to distribute a first subset of samples for a pixel of an image (e.g., pixel samples₀) to a first compute core (e.g., core₀) for sample-based rendering with the first compute core. The illustrated embodiment of the sample-space distributor 140 is further operable to distribute a second subset of samples for the pixel (e.g., pixel samples₁ ) to a second compute core (e.g., core₁) for the sample-based rendering with the second compute core. The second subset differs from the first subset, meaning that it does not contain the same samples. In the illustrated embodiment, the intersection of the first and second subsets is a null set, meaning that they do not contain any samples in common.

If N happens to equal M, each of the cores (i.e., core₀, core₁, . . . , core_{N}) will receive one of the subsets of pixel samples (i.e., pixel samples₀, pixel samples₁, . . . , pixel samples_{M} for sample-based rendering. In the illustrated embodiment, each of the subset of pixel samples is a single sample. In another, related embodiment, each of the cores renders a single sample for every pixel in the image.

If N is less than M, multiple samples of a pixel are rendered in a core in one embodiment. The multiple samples are rendered concurrently or sequentially in alternative embodiments.

In FIG. 1, a sample-space combiner 150 is coupled to the processor 120 and the memory 130 and associated with the sample-space distributor 140. In the illustrated embodiment, the sample-space combiner 150 is operable to combine results of the sample-based rendering performed by the various cores of the processor 120.

In the illustrated embodiment, the sample-space combiner 150 is operable to combine the results of the sample-based rendering performed by the various cores in a single operation. Also in the illustrated embodiment, the sample-space combiner 150 is operable to combine the results by performing a simple average. In another embodiment, the sample-space combiner 150 is operable to combine the results in a sequence of partial combining stages. For example, the results from two cores may be combined to yield a partial combination, then subsequently combined with other partial combinations, and so on, eventually to arrive at a full combination in which all samples have been taken into account. The sample-space combiner 150 may therefore use one or more of the cores of the processor 120 to perform the combining.

As a consequence of the combining of the illustrated embodiment, the memory 130 is caused to contain all pixels of the image, in which all samples have been taken into account in rendering all pixels.

FIG. 2 is a flow diagram of one embodiment of a method of carrying out sample-based rendering in a multi- or many-core processor. The method begins in a start step 210. In a step 220, a first subset of samples for a pixel of an image is distributed to a first compute core of the processing system for the sample-based rendering. In a step 230, a second subset of samples for the pixel is distributed to a second compute core of the processing system for the sample-based rendering, the second subset differing from the first subset. In a step 240, sample-based rendering is carried out in parallel in the first and second compute cores. In a step 250, the results of the sample-based rendering from the first and second compute cores is combined. The method ends in an end step 260.

Those skilled in the art to which this application relates will appreciate that other and further additions, deletions, substitutions and modifications may be made to the described embodiments.

What is claimed is:

1. A processing system, comprising:
a sample-space distributor operable to distribute a first subset of samples for a pixel of an image to a first compute core for sample-based rendering therewith and a second subset of samples for said pixel to a second compute core for said sample-based rendering therewith, said second subset differing from said first subset; and
a sample-space combiner associated with said sample-space distributor and operable to combine results of said sample-based rendering.

2. The processing system as recited in claim 1 wherein said first subset is a first single sample and said second subset is a second single sample differing from said first single sample.

3. The processing system as recited in claim 1 wherein said pixel is a first pixel and said sample-space distributor is further operable to distribute a first subset of samples for a second pixel of said image to said first compute core and a second subset of samples for said second pixel to said second compute core.

4. The processing system as recited in claim 1 wherein said sample-space distributor is further operable to distribute first subsets of samples for all pixels of said image to said first compute core and second subsets of samples for said all pixels to said second compute core, said second subsets differing from said first subsets.

5. The processing system as recited in claim 1 wherein said sample-based rendering is selected from the group consisting of:
true Monte-Carlo rendering, and
quasi-Monte-Carlo rendering.

6. The processing system as recited in claim 1 wherein said first and second compute cores are among at least 100 compute cores.

7. The processing system as recited in claim 1 wherein said sample-space combiner is operable to combine said results in a sequence of partial combining stages.

8. A method of carrying out sample-based rendering in a multi- or many-core processor of a processing system, comprising:
distributing a first subset of samples for a pixel of an image to a first compute core of said processing system for said sample-based rendering;
distributing a second subset of samples for said pixel to a second compute core of said processing system for said sample-based rendering, said second subset differing from said first subset; and
combining results of said sample-based rendering from said first and second compute cores.

9. The method as recited in claim 8 wherein said first subset is a first single sample and said second subset is a second single sample differing from said first single sample.

10. The method as recited in claim 8 wherein said pixel is a first pixel, said distributing said first subset comprises further distributing a first subset of samples for a second pixel of said image to said first compute core and said distributing said second subset comprises further distributing a second subset of samples for said second pixel to said second compute core.

11. The method as recited in claim 8 wherein said distributing said first subset comprises further distributing first subsets of samples for all pixels of said image to said first compute core and said distributing said second subset comprises further distributing second subsets of samples for said all pixels to said second compute core, said second subsets differing from said first subsets.

12. The method as recited in claim 8 wherein said sample-based rendering is selected from the group consisting of:
true Monte-Carlo rendering, and
quasi-Monte-Carlo rendering.

13. The method as recited in claim 8 wherein said multi- or many-core processor processing system is a many-core processor processing system having at least 100 compute cores.

14. The method as recited in claim 8 wherein said combining is carried out in a sequence of partial combining stages.

15. A graphics processing unit (GPU), comprising:
at least 50 compute cores including first and second compute cores;
a sample-space distributor operable to distribute a first subset of samples for a pixel of an image to said first compute core for sample-based rendering therewith and a second subset of samples for said pixel to said second compute core for said sample-based rendering therewith, said second subset differing from said first subset; and
a sample-space combiner associated with said sample-space distributor and operable to combine results of said sample-based rendering.

16. The GPU as recited in claim 15 wherein said first subset is a first single sample and said second subset is a second single sample differing from said first single sample.

17. The GPU as recited in claim 15 wherein said pixel is a first pixel and said sample-space distributor is further operable to distribute a first subset of samples for a second pixel of said image to said first compute core and a second subset of samples for said second pixel to said second compute core.

18. The GPU as recited in claim 15 wherein said sample-space distributor is further operable to distribute first subsets of samples for all pixels of said image to said first compute core and second subsets of samples for said all pixels to said second compute core, said second subsets differing from said first subsets.

19. The GPU as recited in claim 15 wherein said sample-based rendering is selected from the group consisting of:
true Monte-Carlo rendering, and
quasi-Monte-Carlo rendering.

20. The GPU as recited in claim 15 wherein said sample-space combiner is operable to combine said results in a sequence of partial combining stages.
